(19) United States
(12) Patent Application Publication
(10) Pub. No.: US 2010/0140473 A1
(43) Pub. Date: Jun. 10, 2010

(54) NANOROBOT MODULE, AUTOMATION AND EXCHANGE

(76) Inventor: Volker Klocke, Stolberg-Breinig (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/596,707

(22) PCT Filed: Apr. 24, 2008
(86) PCT No.: PCT/DE08/00699

§ 371 Date: Dec. 30, 2009

(30) Foreign Application Priority Data
Apr. 24, 2007 (DE) 102007019623.9
May 8, 2007 (DE) 102007022045.8
Jul. 27, 2007 (DE) 102007035761.5
Jul. 30, 2007 (DE) 102007035950.2
Jul. 30, 2007 (DE) 102007036019.5

(51) Int. Cl. G01B 21/30; G01B 21/20; G01B 5/28; G01Q 70/00

(52) U.S. Cl. 250/309; 250/311; 73/105; 850/52; 977/953

(57) ABSTRACT

A nanorobot module with a measurement device for the measurement of spatial surface properties with a measurement range in the centimetre range and a resolution in the nanometre range, that can be arranged in a vacuum chamber, for example the vacuum chamber of a microscope. Along with this integration of the nanorobot module into a vacuum chamber, the disclosure further relates to the automation of the module in the chamber system, in particular the connection of the controller of the nanorobot system and the chamber system by the provision of an interface between both systems. Finally, the disclosure relates to a mechatronic exchange adapter for the flexible securing of nanorobot modules within a vacuum chamber, in particular the disclosure relates to an exchange adapter, which preferably in one process electrically connects a nanorobot module and mechanically secures it so that it is guided with high precision and without play.

### BACKGROUND

1. Field of the Disclosure

The disclosure relates to a nanorobot module with a drive device and a method for its use, in particular for the measurement of surface properties, and to a system with a vacuum chamber in which a nanorobot module is arranged. The disclosure further relates to an exchange adapter and a method in particular for exchanging nanorobot modules.

2. Discussion of the Background Art

Nanorobot modules are generally understood to mean actuators with positioning resolution in the nanometer range and displacements into the mm or cm range, such as for example linear drives, positioning tables, grippers for example with movable jaws, or rotary drives, rotary tables, pivoting modules with positioning resolution into the nano-degree range and movement ranges of many degrees, as well as multi-axis drives and/or manipulators and the combination of such modules to form systems with many degrees of freedom of movement.

These nanorobots can also incorporate various sensors. These nanorobot modules mostly include so-called “end effectors”. These are objects which are moved by these nanorobot modules. Such objects can be for example tools such as tips, cutting edges or grippers, or they can be sensors for measuring data parameters. End effectors can also be combinations of tools and sensors.

Measuring units are normally used to measure spatial surface properties such as for example contours, topographies, and roughness, as well as various coordinate of objects. The measuring units used, for example profilometers or coordinate measuring machines, can as a rule determine at least a part of these parameters.

The limitation to a part can for example also involve the reduction to only one or two dimensions. The measurement can be carried out in a contacting or contact-free manner, and may contain different sensor principles in the form of various probes for the measurement of surface properties.

Measuring units also have scanning probe microscopes, but due to their restricted imaging area these are not suited to the quantitative measurement of larger test areas.

To achieve usable precision, conventional measurement units require high masses for vibration isolation, for example in the form of granite slabs. Typical weights of such systems lie between 50 and 2000 kg. Very large systems are therefore involved, which are normally installed in air and on large, massive granite tables.

Due to their size as well as to the materials used, the measurement units are not suitable for use in a vacuum. Neither is there space available in a vacuum chamber for vibration isolation or the large masses present, nor is it guaranteed that the materials used will not outgas.

Also, one-axis to three-axis or more manipulators are known from the prior art. However, these are normally motion control units. While it is true that these have a movement resolution down to the sub-nanometre range, they have neither guiding accuracy, repeat accuracy nor even absolute positional accuracy, and yet they are free of errors, such as pitching, yaw, tilting, creep, undulation or thermal drift on the nanometre scale.

Owing to these disadvantages, the known manipulation units are not suitable for use as measuring units. For if such a drive is to be used as an element of a measuring unit, its movement with sub-nanometre resolution is only a necessary condition, but by no means a sufficient one. For normal applications, high resolution is sufficient as the only feature. The prior art in measuring units in air therefore shows that even there such drive systems are not usually used.

Nanorobot modules can have numerous other measuring or manipulation units—such as, e.g., linear drives, positioning tables, grippers, for example with movable jaws, or rotary drives, rotary tables, pivoting modules with positioning resolution as well as multi-axis drives or manipulators, and the combination of such modules for systems with many degrees of freedom of movement.

Some of these actuators can be equipped with travel measurement units so that they can also perform absolute positioning. Nanorobot modules can also have various sensors, which are integrated in actuator modules, are moved by actuators or are simply a component of nanorobot modules.

Moreover, nanorobot modules mostly have so-called end effectors. These are objects which are moved by the nanorobot modules. Such objects can for example be tools such as tips, cutting edges or grippers, or they can be sensors for measuring data parameters. End effectors can also be combinations of tools and sensors.

Nanorobot modules normally require at least one cable per drive for supplying power, plus a common movement return lead. Usually however, far more cable connections are required, in particular if sensors are included. For example, force-measuring cantilevers already require four cables and high-resolution position sensors require more than ten cables.

Many types of vacuum chambers are also known from the prior art. Vacuum chambers can consist of single or multiple cells connected together by air-locks and/or valves, which can be operated respectively under vacuum of any degree (low vacuum, high vacuum, ultra-high vacuum) or under protective gas of any gas type, hence also clean-room type filtered air. The fitting of these vacuum chambers with various components and devices as well as the controller leads to application oriented systems, such as for example vapour deposition chambers, sputtering chambers, laser ablation chambers, scanning electron and/or scanning ion microscopes, transmission electron microscopes, wafer handling systems in vacuum or protective gas, super-clean room systems in vacuum, protective gas or filtered air.

The integration of conventional measurement units into such chamber systems is more or less impossible, because they are too large to be installed into a vacuum chamber. Conventional systems for preventing the coupling of external vibrations by the use of massive or bulky materials are not feasible in the chamber interior. If on the other hand nanorobot modules are to be integrated into such chambers, the operation of the nanorobot module in the chamber is difficult because chamber systems enable only limited visibility and their manual operation is relatively slow. Also, the risk of damaging fine measurement tips during the approach or measurement is very high.

Based on the difficult accessibility, nanorobot modules are usually installed once in a vacuum chamber permanently and the often extensive cable sets of these modules are laid as far as the chamber access passage. A disadvantage of this solution is that works to be carried out on the nanorobot module by the operating personnel, such as for example the replacement or maintenance of an end effector, involve very high cost.

The nanorobot modules are difficult to access in often relatively small vacuum chambers filled with highly sensitive equipment and the handling space is extremely limited. Moreover, the limited visibility into such chambers is additionally hindered by the installed equipment. Space for microscopes for acquiring detailed information is therefore usually not available. Every false hand movement, furthermore, can damage expensive devices. The precise adjustment of in some cases very small and extremely sensitive end effectors on the nanorobot modules is scarcely possible under such difficult conditions.

For this problem, two approaches to implementation are known from the prior art. Firstly, the cable sets to the nanorobot modules can be lengthened to the point where the modules can be taken out by their cables hanging out of the vacuum chamber. All operations must then take place in the free space directly in front of the chamber opening, a location that hardly offers appropriate working conditions with support from devices such as lamps, a table, clamps for fixing, microscopes, tools and so on. Moreover after conclusion of the work the much too long cable set must be laid somewhere in the vacuum chamber again, without running the risk of getting tangled up in movable objects, such as for example travelling sample platforms. Reports from users of such a solution show that it often results in damage to these over-long cable sets. This can eventually lead to malfunctions that are difficult to localise.

The problem addressed by the present disclosure therefore, is to improve already known nanorobot modules, in particular to enable a measuring unit to operate in a vacuum chamber.

### SUMMARY

It is of particular advantage here if a nanorobot module, in particular for measuring surface properties, has a measurement unit with a measurement probe with a solution in the nanometer range and a measurement range in the centimetre range. This has the advantage that large surfaces can be measured, wherein a high resolution is simultaneously enabled at individual points of the object.

### BRIEF DESCRIPTION OF THE DRAWINGS

The disclosure is explained in more detail below with the aid of several exemplary embodiments and with reference to the drawings. These show:

FIG. 1 a schematic construction of a nanorobot module in a vacuum chamber of a scanning electron microscope and/or focussed ion beam microscope,

FIG. 2 a schematic construction of a nanorobot module in a vacuum chamber of a vapour deposition chamber for coating materials,

FIG. 3 a schematic construction of a nanorobot module in a vacuum chamber of an analysis chamber,

FIG. 4 a schematic construction of a nanorobot module in a vacuum chamber of a super-clean room chamber, that can be operated under vacuum, protective gas or as a miniature clean room with filtered air,

FIG. 5 schematically, a construction of multiple nanorobot modules in a chamber system with manual control,

FIG. 6 schematically, a construction of a nanorobot module with an automated controller,

FIG. 7 schematically, a construction of a combination of a chamber system and a nanorobot module over an interface

FIG. 8 schematically, a construction of a combination of both systems over an interface and the automation of the overall system,

FIG. 9 schematically a construction of an exchange adapter,

FIG. 10 the individual steps of the functional principle of the Specht method for surface measurement along a line,

FIG. 11 schematically the functional principle of the Specht method along several lines and

FIG. 12 schematically the functional principle of the Specht method applied to an internal contour shaped as desired.

FIG. 13 an exemplary embodiment of a nanorobot module.

### DETAILED DESCRIPTION OF THE PREFERRED EMBODIMENT

More advantageously the nanorobot module has a manipulation unit with an end effector. If the nanorobot module simultaneously has an end effector, i.e. for example a tool such as a tip, a cutting edge, a gripper, an erosion probe, a grinding agent or similar, this end effector can be automatically moved close to an object using the functionality of the measurement unit, without the position of this object relative to the end effector being known, in order to stop at an extremely small distance from or in contact with the object, depending on the probe. Thus, the position of this end effector relative to the object is known and the end effector can perform its function, so for example processing the object or clawing its way along it.

If the end effector is a sensor, i.e. for example a force sensor or a sensor that can detect other signals such as current, light, magnetic field, temperature or for example material properties such as hardness or the like, in the same way as a tool this sensor can be automatically brought close to an object by means of the drive device. This simplifies and reduces the movement of end effectors towards the object.

The measurement probe can be sensitive in several spatial directions. This enables it to feel a surface in not only one spatial direction, but rather in several.

Furthermore, the measurement unit can be mobile along several dimensions. This enables the measurement of height difference such as steps, or the determination of thicknesses by difference measurement, the creation of profiles along project surfaces, the detection of three-dimensional surface profiles, the measurement of internal and external object contours as well as the determination of object dimensions, such as for example distances, angles, diameters, intersections and various coordinates and the measurement of object roughness along upper paths and surfaces.

It is advantageous if the drive device has piezoelectric or comparable drives. These enable a movement precision in the nanometre range.

Since these as a rule only have a maximum available elevation of several hundred microns, for measurement on the millimetre to centimetre scale a further drive element is advantageous.

This can be a classic motor drive, which normally leads, however, to a large structure with low precision. In particular a drive can be used which as well as the limited fine positioning range is capable of a type of step mode bridging of large distances. Typical variants are piezoelectric or comparably driven inertia drives, travelling wave drives, pulse wave drives, so-called crawlers or clinging runners working according to the inchworm principle. These drives are small and possess a high movement resolution.

Advantageously the drive device has position sensors, since these enable absolute positioning and allow it to assign its probe data to absolute locations.

In order to attain a sufficiently large positional accuracy, the position sensors can have a resolution in the nanometre range.

It is particularly advantageous if the drive device is constructed in a thermally compensated manner, in order to reduce thermal drift in directions that are not visible to the position sensors.

Due to a small assembly size of a few centimetres, by the use of extremely precise guides, optimised materials, levers, turning moments and connecting elements, the axial errors that are not visible to the position sensors, such as pitching, yaw, tilting, creep, thermal drift or undulation are sufficiently sharply reduced. This is useful in particular for the combination of multiple drives or for measurement with multiple probes in the same coordinate system. A linking of the measurement along a precise travel axis as in classical profilometers therefore does not apply.

It is of further advantage if the nanorobot module has a volume of less than 50×s 50×s 50 cm³. Such a size reduction allows a higher vibration insensitivity to be obtained. If the dimensions are further diminished, the vibration sensitivity decreases even more.

It is particularly advantageous if a measurement unit is suitable for operation in a vacuum. This opens up completely new possibilities in quality control, research, development and production.

For example, in a vacuum chamber that is equipped as a scanning electron microscope (SEM), the measurement unit for measuring surface properties can be used to carry out 3D-measurements on samples that are being examined or processed with the facilities of the SEM. The combination of both technologies offers an enormous enhancement to the process of sample characterisation: The 3D-measurement expands the measurement properties of the SEM and the high imaging resolution of the SEM enables the imaging of the area of the sample on the sample table in which the 3D-measurement is to take place.

Thus, the 3D-measurement can meaningfully be used on far smaller object areas than in air, because in air the poor resolution of optical microscopes represents a limitation. Moreover the 3D measurement of sample points can be performed, which were specifically identified in the SEM using the facilities of the SEM. An example of this is a foreign body, identified in a basic matrix by means of x-ray examination or EDX. An optical microscope would not be capable of identifying such foreign objects.

In vacuum chambers that are equipped as focussed ion beam microscopes (FIB), the measurement unit for measuring surface properties can be used to carry out 3D-measurements on samples that are being examined or processed with the facilities of the FIB. The combination of both technologies offers an enormous enhancement to the process of sample characterisation: the 3D-measurement enables the structures produced by means of the FIB on or near a sample to be measured in the same vacuum chamber in all 3 dimensions. The 3D measurement therefore offers a novel facility for controlling the FIB process.

Vacuum chambers exist on the market, moreover, that combine the functionalities of both the scanning electron microscope (SEM) and the focussed ion beam microscope (FIB) in one device. The installation of a 3D measurement capability in such a combination device would combine all the advantages of the 3D measurement of both individual devices and would multiply the possible applications.

In vacuum chambers that are equipped as vapour deposition chambers for the coating of samples, 3D measurements can be carried out on sample structures that are produced by coating in the vapour deposition chamber. The 3D measurement therefore offers a novel facility for controlling the vapour deposition process.

In vacuum chambers that are equipped as super-clean room chambers and can be operated under vacuum conditions or under protective gases, the handling, measurement and processing of highly sensitive goods takes place. These are, for example, wafers or other components of semiconductor manufacturing right up to complex devices such as entire hard disks, which are made in these vacuum chambers.

The integration of the 3D measurements offers for all these applications a further important test method, which has not been previously available in such an environment.

Further advantage is gained if the nanorobot module has multiple drives. This enables both measurement and pre-processing to take place in several spatial directions.

The nanorobot module can have multiple probes for measurement or processing. Also due to this, measurement and processing in several spatial directions becomes possible.

The nanorobot modules and end effectors moved by them, in particular a probe, can have a storage device for state information about their size, composition, elevation, condition, design, electrical or mechanical parameters. This makes various parameters easier to adjust during the installation or exchange of nanorobot modules.

A further idea of the disclosure comprises a system with a vacuum chamber, in which a nanorobot module is arranged, wherein the vacuum chamber has a free internal volume with an edge length less than 60 cm, preferably less than 30 cm. A reduction in size of a measurement unit by the use of a nanorobot module of this size diminishes the external vibration coupling, wherein a simultaneous restriction of the chamber to this size means that a vacuum can be produced more quickly.

A system with a vacuum chamber in which a nanorobot module is arranged, the nanorobot module being mounted on a flange of the chamber, is also covered by the inventive idea. If the assembly of the nanorobot module takes place on the inside of a chamber flange and the power connections necessary for the operation of the nanorobot module are also preferably integrated in this flange, the cable harness from these power connections to the nanorobot module becomes very short and the entire unit with the flange and the nanorobot module can be simply removed from the chamber by loosening the flange screws.

It is further advantageous if the system has a computer, that controls the individual steps of a measurement. This enables an automation of the entire measurement sequence and therefore brings clear time savings.

At the same time the vacuum chamber and the nanorobot module respectively can both have a controller and the connection to the controller can take place via an interface. The presence of such an interface enables the combination of the information from both units. A common interface enables the controllers of both systems to be connected. Via this interface, the following functionalities can be implemented either singly or in combination:
1. The nanorobot controller queries information on components or system states of the chamber system.
2. The nanorobot controller changes components or system states of the chamber system.
3. The chamber system controller queries information on components or system states of the nanorobot.
4. The chamber system controller changes components or system states of the nanorobot.

The realisation of such a unified system offers numerous advantages. These are to be clarified in the following with the aid of examples:

If a system queries the states of the components of the other system, it can then draw conclusions from this information for its own actions. Thus the nanorobot controller can for example query the positions of movable components of the chamber system and therefore knows where obstacles are.

If a system drives actuators of the other system, then the functionality of the system itself can be extended. Thus the nanorobot controller can, for example, move the sample platform of the chamber system, in order to move samples placed on the platform into the working range of the nanorobot modules. These sensor-actuator controllers can be combined as desired and therefore multiply the possibilities of the combined system.

If one of the two system controllers (nanorobot or chamber system) possesses automation software, this can also perform the automation of the other system, as well as the automation of all controllable sensors and actuators of both systems. This enables the automation of an entire system, even if this consists of two separate systems, that mostly come from different manufacturers.

If an independent set of automation software is connected to the interface between the chamber system controller and nanorobot controller, this can perform the automation of all controllable sensors and actuators of both systems. This also enables the automation of the entire system. It is therefore fundamentally of no importance whether the automation is a component of the controller of one of the two single systems or acts as an independent package over the common interface.

It is furthermore advantageous if the interface is addressed by an automation system. At the same time the automation can take place via computer programs, SPS controllers, microcontrollers or embedded systems—i.e. computer controllers integrated in hardware.

Advantageously the automation is achieved by frequently required sequences such as approaching reference points, moving into parked positions, moving into working points and finding certain points through an automatic interaction between chamber and sensor data.

An automation further permits the free programming of processing sequences by use of the nanorobot sensors available for automation and preferably nanorobot actuators with absolute positioning, also together with the use of software variables, formula calculations, loops, case distinctions and simultaneously running processes.

Addressing the interface allows both the conditions in the chamber system and the conditions at the nanorobot module to be synchronised in a single process.

The chamber system in principle always contains sensors, and often also actuators, that are required to implement the functionality of this chamber system. Also nanorobot modules have a plurality of sensors and actuators, as well as end effectors at their disposal. A summary of these data and coordination of the occupancy of the different modules therefore leads to great flexibility in application.

In particular, if the nanorobot components or end effectors moved by them contain state information about their size, composition, elevation, condition, design, electrical or mechanical parameters, these can be automatically evaluated, archived and in particular used for handling, measurement or automation processes.

A further aspect of the disclosure relates to a method for using a nanorobot module according to the disclosure, wherein the contact between measurement probe and sample is interrupted during a measurement. This enables the use of probes that also have a lateral resolution down to a few nanometres. Such probes are either contactless probes, that work extremely close to the surface to be measured, or contacting “tactile probes”, which come into contact with the sample to be measured. At the end near the sample these probes must be as small as the desired lateral resolution at this point.

Assuming the probe and/or the sample is positioned with sufficient resolution, the diameter of the probe determines the lateral spatial resolution of the measurement. A measurement resolution of 10 nm therefore requires a tip diameter of the probe in the same order of magnitude. That makes clear that lateral high-resolution probes are as a rule extremely sensitive.

Up to now therefore, two reasons have prevented the use of such sensitive probes:

Firstly: All drives fundamentally generate vibrations during operation over distances that are greater than their vibration-free fine positioning operation. These vibrations produce relative movements between probe and sample being measured that can are highly likely to lead to the destruction of the probe or to unintentionally modify the sample.

All damping systems which decouple the drives of probe and sample cause a falsification of the measurement results, for example by creep or damping, thermal expansion of the damper or a slurring of the vibration into a slower undefined movement. Moreover, dampers cause vacuum problems due to the outgassing of electrical components, or for example by spontaneous evaporation of trapped air. An integration of a vibration damper would therefore destroy the nanometre precision and would be problematic in terms of vacuum technology. The vibrations so generated would normally lead moreover to the destruction of the measurement probe.

Secondly: Even the frictional wear occurring during the long-term contact between probe and sample typical of profilometer style operation destroys the lateral high-resolution probes.

A measurement that is not effected by a long-term contact between measurement probe and sample, therefore enables both these problems just mentioned to be avoided and the lateral high-resolution probes to be used.

Advantageously, during the execution of the method the distance between measurement probe and sample to the contact is first of all reduced and then maintained.

This prevents any penetration of the measurement probe into the sample and an associated destruction of the measurement probe itself, as well as an unintentional manipulation of the sample surface.

If contact of measurement probe and sample is not achieved over the entire fine positioning range of the drive device, the distance between probe and sample can be increased by a defined distance before a coarse approach step is made over less than this defined distance and the distance from sample to probe is again reduced. In this way an approach can take place over many centimetres, without the probe overshooting and colliding with the sample.

If the probe simultaneously contains an end effector with additional functionality, then with this approach method this end effector can be automatically brought close to an object, which replaces the very time consuming manual process that is otherwise common and risky for the end effector.

At the same time the position value on the line of approach can be stored. This later enables a plot of the individual surface points.

The position value can furthermore be modulated with the sensor value. This enables a more accurate specification of the measurement.

In a subsequent step, the distance from measurement probe to sample can be increased by a defined amount and in a third step the measurement probe moved by a defined distance sideways to the sample. This means that even in the case of large variations in the sample surface, penetration of the measurement probe into the sample is prevented. Moreover measurement of larger sample surface areas becomes possible.

The steps described can be carried out repeatedly. This enables measurement of large areas.

If the probe is not evaluated in the manner for which it is designed for measuring the surface contour, but only gives a pulse as soon as it reaches a predefined signal value, then this involves only the transmission of a trigger signal, which can be carried out as quickly as desired.

If the distance for the withdrawal of the sample is for example continuously adapted to the sample structure sizes by means of an adaptive algorithm, this further accelerates the measurement. If furthermore the classic zoom function is also realised for the measurements accordingly, the spatial measurement of surface properties such as for example 2D and 3D contours, topography, roughness and various coordinate measurements on objects is possible in a shorter measurement time.

Measuring instruments that gather 3D datasets with many measurement points scan the entire measurement area in the measuring instrument's own resolution and gather all data points. One can later zoom into this dataset using software and look at small extracts as desired. In a surface measuring instrument with 10 nm resolution over a measurement area of for example 50 mm×50 mm, that is 50 million nm×50 million nm, this measurement method would take at least several weeks to months.

The method according to the disclosure for permits a considerably more effective zoom method: only as many points in the space are ever approached and measured as are necessary for the representation of the field currently of interest. To obtain the first coarse image of a coin, for example, 100 points in the X direction and 20 to 50 scans in the Y direction are sufficient, which are quickly measured.

In this coarse overview image, a small interesting extract can now be selected, in which a new measurement with similarly few data points is carried out at similar speed. Instead of the software zoom in an immensely oversized data field, only the area of interest is measured. The measurement time does not depend substantially on the measurement area but rather on the number of points to be measured. This is an essential advantage in comparison with classical scanning devices, whose measurement time depends mainly on the distance to be measured.

The measurement probe can also be moved sideways to the sample until the point of contact. If the movement is thus stopped by the contact between the measurement probe and the sample, in the case of sideways movement penetration of the measurement probe into the sample is also prevented.

In a subsequent step, measurements can be made with the scanning method in direct contact with the sample. It is due to this that the method according to the disclosure and the scanning method can be combined. This enables an increase in speed and resolution in comparison to the pure scanning method and to the method in accordance with the method according to the disclosure.

A computer can control the individual steps one after another. This enables automation to occur as well as the gathering of more data points in a controlled period.

It is further advantageous if the measurement takes place resulted along any desired spatial directions, which means the measurement is not restricted to the axial alignment of the drives.

The measurement can follow surface contours and by taking rows of measurements, surfaces can be scanned.

With suitable probes, surface contours, interior contours of cavities, undercuts, external contours, external lines, deep trenches or sharp cutting edges can be measured with nanometre precision in up to three dimensions.

It is advantageous if the readings acquired are sufficient to determine roughness values. By this method, contours and dimensions of objects can be determined from the measurement data according to various standard definitions with nanometre precision in up to three dimensions.

A further idea of the disclosure concerns an exchange adapter, in particular for exchanging nanorobot modules, according to the disclosure, characterised in that it has an electrical plug and socket system with plug and socket and a mechanical fastening unit with a mechanical guide and a carriage. It is obvious that a converse arrangement of the modules of the electrical plug and socket system and the mechanical fastening unit is also meaningful.

The use of such an exchange adapter enables the nanorobot module to be removed from the measurement device. This is of particular advantage when the system is operated in vacuum chambers, because such a removal from the chamber is facilitated without the movement space being restricted by a cable set.

Simultaneously with the mechanically detachable fastening in the chamber, an additional electrical plug and socket system with many plug contacts is provided here. A combination of both plug and socket systems is necessary because the electrical connection process carries additional risk due to the amount of cable cores. The larger the connector that hangs on the end of a cable harness, the more at risk is the entire nanorobot module, because the force required for the plugging and unplugging process also usually increases with the number of poles of an electrical connector. The unplugging of this connector can lead to various types of damage to the nanorobot module as well as to the chamber equipment during installation into a vacuum chamber.

Certain requirements must also be placed on the mechanical connection in this process. In the fixed state, no mechanical play must be allowed to couple vibrations into the nanorobot module. In the case of fastening methods involving large mass, the vibrations on average have values of less than 10 nm, which is a prerequisite for the nanometre precision of the nanorobot module. Also, after installation and de-installation the positioning should end as closely as possible at exactly the same place, so that the position of the end effector secured on the nanorobot module remains at the same place. In contrast to simple fastening methods, such as for example those involving only threaded screws, the proposed solution enables an exactly reproducible positioning.

In this case, the socket of the electrical plug and socket system can have a connection to the guiding system of the mechanical fastening unit and the plug can have a connection to the carriage of the mechanical fastening unit. A connection from the socket to the carriage and from the connector to the guiding system is also conceivable. This fastening method facilitates a pre-adjustment of both units.

It is advantageous if both plug and socket connectors, or at least one of them, is mounted in a floating manner on the parts of the mechanical fastening unit. These can then be moved in a relatively force-free manner and can harmlessly avoid the shearing forces arising in the connection process. Obviously it is also sufficient if only the plug or the socket is mounted in a floating manner.

It is advantageous here in particular if the floating mounting has so little play that plug and socket can still centre themselves securely, but simultaneously have enough play themselves such that in the mechanical fixing, little or no shearing forces are exerted on the electrical plug and socket connection.

At the same time the parts of the electrical plug and socket system can be fixed to the parts of the mechanical fastening unit. Due to this, the connector and its counterpart are mechanically fixed in the ideal position in a single action, without lateral forces recurring in the process. Because the basic adjustment must take place only once, the expense involved can be considerably higher.

A variant of the powered fine fixing of this optimal position is the use of vacuum suitable adhesive. This adhesive must be mechanically stable enough that it is not shaken loose in the operation of the exchange adapter. A solution to this is the production of gaps, that are filled with adhesive: One side of the adhesion site fixes the plug connector or its counterpart, the other side is closed off with a massive block that is not movable. One or more of these immovable adhesion sites hold the connector or its counterpart in its ideal position and can simultaneously withstand high insertion forces.

The plug and the socket can have at least one connector contact. In complex measuring or end effector systems, several plug and socket contacts will normally be necessary however.

Advantageously, the mechanical fastening unit has a fixing for a carriage and guide system. This allows the carriage to be easily pushed into the guide and following that, the fixing can take place. It is thus possible to plug in the nanorobot module quickly and easily with only one hand and if necessary to release it, for example to grasp it with the hand and to subsequently fix the nanorobot module in place.

For this, a precision of more than 300 μm, preferably in the range of a few μm, is advantageous. This makes possible a positionally exact localisation of the nanorobot module. To achieve exact positioning it can also be practical if the guide exhibits play and vibrations of less than 1 μm, preferably of less than 100 nm.

A particularly simple manufacturing method provides that the mechanical fixing is made of metal. Manufacture from ceramics can be advantageous in the light of the use in a vacuum.

A further idea of the disclosure also comprises a method for exchanging nanorobot modules, characterised in that a nanorobot module is first mechanically fixed and electrically connected.

A further aspect of the disclosure comprises a method with an exchange adapter, in particular for exchanging nanorobot modules, wherein a measurement unit is mechanically fixed and electrically connected.

The method enables for example a nanorobot module to be mechanically fixed at a reproducible position and an electrical plug and socket contact to be simultaneously made. By the combination of the two steps, it is possible simultaneously to fix the nanorobot module in a vibration-free manner at an exactly predefined position, without any relative movement and the associated high shearing forces destroying the connector and socket, or at least making them stiff and increasing the wear.

It is advantageous here if the connector connected to the measurement unit has been pre-fixed to the carriage mechanism in a preliminary step and the socket connected to the cable cord has been pre-fixed to the cable cord on a guide mechanism in a preliminary step.

This pre-fixing, for example using an only very loosely fixed screw connection, has the advantage that the connector units remain movable with respect to each other.

In a first step the carriage can be pushed into the guide in a manner such that the nanorobot module securely holds its position by itself. This enables it for example to be grasped during installation.

In a second step, the carriage can be pushed further into the guide so that the connector and socket become electrically connected. In the process, the mechanical plug and socket system is first connected to the mechanical fixing in a vibration-free manner at an exactly predefined position. The electric connector modules can still be moved in a relatively force-free manner and thus avoid the resulting shearing forces.

Now the plug and socket are pressed onto each other once again in order to create the electrical connection fully and securely. Subsequently the electrical connector and socket are mechanically fixed in this ideal position in a single action, without shearing forces recurring in the process.

One possibility for fixing the connector system components to the components of the mechanical fastening unit is to connect them using adhesive at a position determined by a basic adjustment stage. If the adapter is to be used in a vacuum, the use of vacuum suitable adhesive is advantageous. This adhesive must be mechanically stable enough that it is not shaken loose in the operation of the exchange adapter.

A solution to this is the production of gaps, that are filled with adhesive: One side of the adhesion site fixes the plug connector or the socket respectively, the other side is closed off with a massive block that is not movable. One or more of these immobile adhesion sites hold the connector or socket respectively in its ideal position while nevertheless also withstanding high insertion forces. Fixing by means of straightforward adhesion points is also. This fixing is only provisional in nature and is only intended to be sufficient so that a force acting on the least firm mechanical fixing of connector or socket does not move it out of the ideal position during fixing. In this way a mechanically stable fixing can be obtained, even if the adhesion points were not able to withstand the insertion forces in the long term. This provisional adhesive fixing could fundamentally also be effected by mechanical clamping or for example magnetically, if such fixings can be successfully made without slipping of the components.

In a third step, the plug connector and the carriage as well as the socket and the guide are finally mechanically fixed in a subsequent step. This means that the nanorobot module is fixed exactly in position and in a vibration-free manner.

Advantageously, the final fixing of the nanorobot module is made at a reproducible position. The direct deployment of the nanorobot module in this position then becomes possible.

It is advantageous furthermore if the final fixing of the nanorobot module is effected in a maximally vibration-free manner. This means that measurements in the nanometre range become possible.

Also a final fixing of the nanorobot module in a stable manner reduces the coupling of vibrations into the system and increases the measurement accuracy.

A further idea of the disclosure comprises a system with an exchange adapter and with an additional base part of this exchange adapter with a guide and socket, with a measurement unit, at least one cable harness, at least one set of electronics and a vacuum chamber, wherein the measurement unit that is secured on the rail and electrically connected to a connector can be connected to both base parts.

This means that a nanorobot unit can be used both in structures in vacuum chambers and also in structures outside of the vacuum. The nanorobot module can be easily switched between vacuum chamber application and air application, preferably without cable harnesses having to be removed from the vacuum chamber in the process.

The flexible use of the usually expensive nanorobot module in two different environments is an advantage here: within the vacuum chamber and simultaneously for example in air in a frame construction, which also provides the stationary part of the exchange adapter and a permanently laid cable harness. Thus, all the described advantages and measurement methods of the 3D measurement unit developed for vacuum chambers can also be used in air. If both the cable harnesses from the vacuum chamber and the air assembly also lead to the same set of electronics, and are there switched over as required, a doubly usable system results for the price of one, plus cable harness and stationary part of the exchange adapter. This enables much reduced construction costs, because these components represent the lowest part of the costs.

The extension of the exchange adapter principle also to the end effector in particular alleviates the exchange of end effectors that optionally require a series of electrical supply lines. At the same time these end effectors can be composed of the actual sensor or actuator, which is pre-mounted in each case on a standardised adapter.

The adapter merges into the movable part of the exchange adapter or already constitutes the movable part of the exchange adapter.

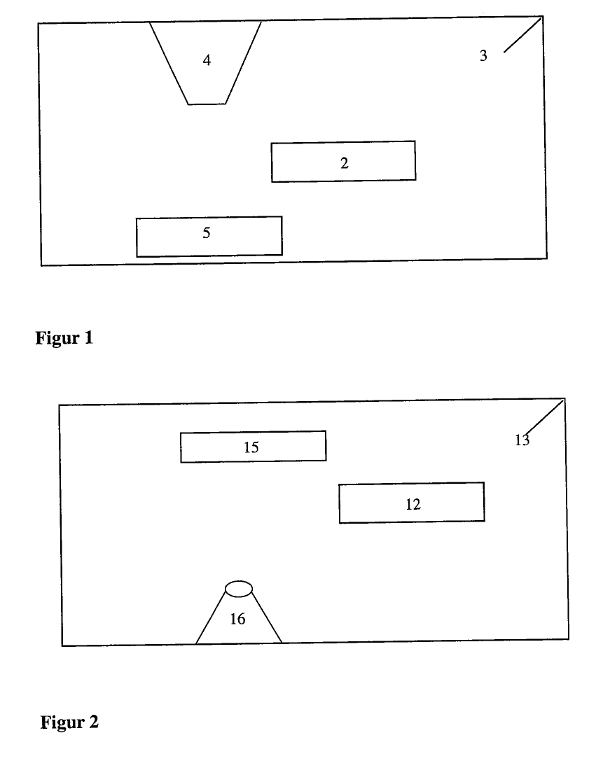

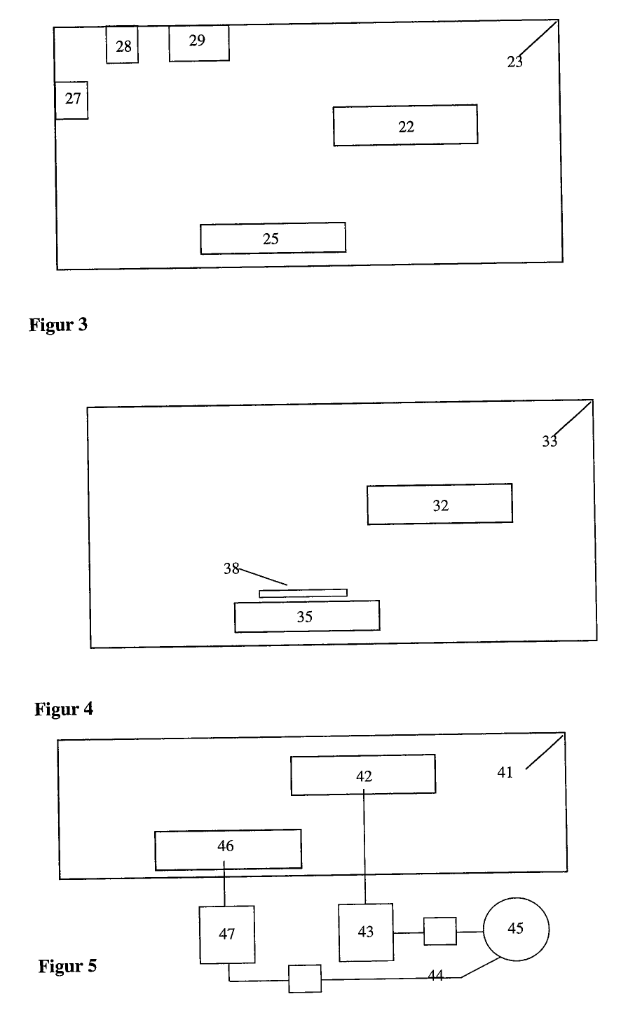

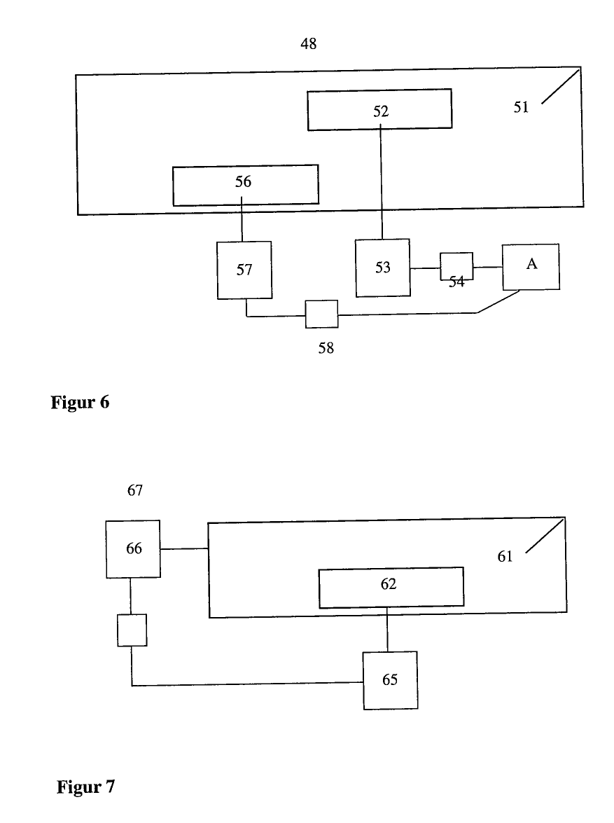

As shown in FIGS. 1 to 4, a nanorobot module 2, 12, 22, 32 and respectively a sample table 5, 15, 25, 35 is arranged in a vacuum chamber of variable function 3, 13, 23, 33. FIGS. 1 to 4 show adaptations of this basic construction. According to the application, a scanning electron microscope or a focussed ion beam microscope 4 or a device for the vapour deposition of materials 16 can be used. In addition to these components, various analysis devices 27, 28, 29 can be located in the chamber. In an application illustrated in FIG. 4 of the nanorobot module in a vacuum chamber of a super-clean room chamber, that can be operated under vacuum, protective gas or as a miniature clean room with filtered air, a wafer 38 to be measured for example lies on the sample table 35.

The system represented in FIG. 5 consists of a chamber system 41 with various nanorobot modules 42, 46, which can have both actuators and sensors, two controllers for the nanorobot modules 43, 47, two interfaces between controllers and manual control 44, 48 and a manual control 45, for example a joystick, game port, keypad, keyboard, graphical user interface or voice controller.

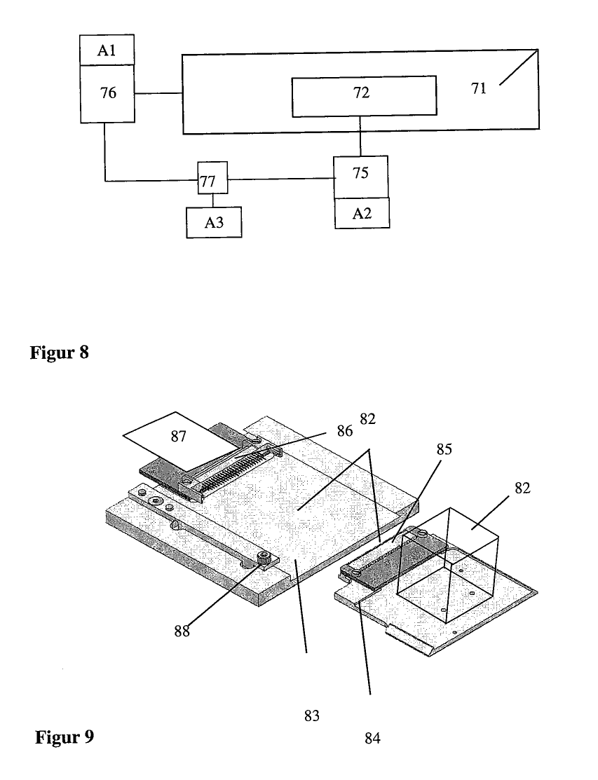

FIG. 6 shows how the manual control can be replaced by an automation system A, for example in the form of computer programs, SPS controls, microcontrollers or embedded systems, i.e. computer controllers integrated in hardware.

FIG. 7 shows the connection of the chamber system 61 to the manual controller 66 of the chamber system and of the nanorobot module 62 to the manual controller 65 of the nanorobot module over an interface 67 between chamber system controller 66 and nanorobot controller 65. This interface 67 enables data to be transferred between the various controllers 65, 66.

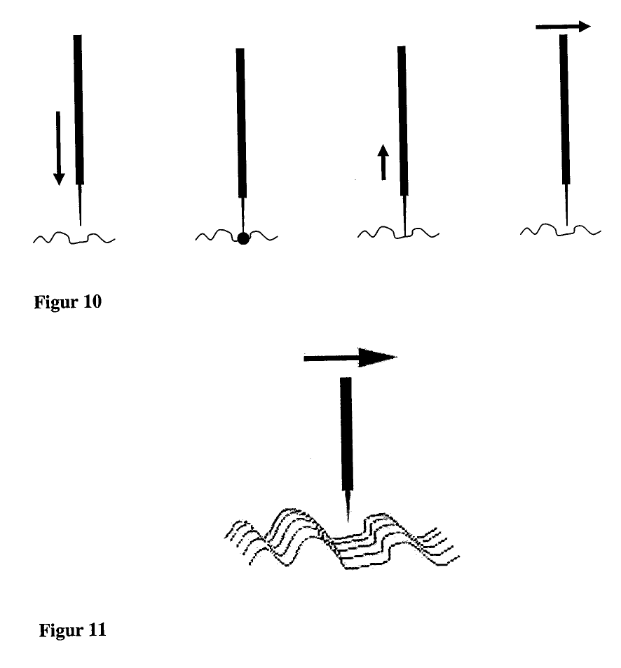

FIG. 8 shows the different possibilities for installation of an automated system as either a component of the two separate systems, as a component of the chamber controller A1 or as a component of the controller of the nanorobot module A2, or as an independent component at the common interface A3.

In accordance with one exemplary embodiment, the automation is implemented by means of a software package of the nanorobot module 72, i.e. by means of module A2 in FIG. 5. This automation has access to the functional units of the nanorobot 72 in a similar manner to the manual control. Moreover, it has access to the interface 77 of the chamber system and via this it can use the functionality of the chamber system 71 in a similar manner to a manual control of the chamber system.

A user-friendly variant of this system is the integration of the functional module of the chamber controller 76 into the user interface of the manual nanorobot controller 75. The sum of all functionality of the overall system thus appears in the user interface of the manual nanorobot controller 75. An automation system A2, which permits a programmable control of all functional modules thus integrated into the manual nanorobot controller 75, corresponds to the homogeneous automation of the entire system.

A particularly advantageous arrangement of this automation system is a type of recorder that records command sequences of the manual controller and reproduces them later as automated sequences. If such an automation software system also contains the basic functions of all programming language such as grouping of commands into functions, creation of loops and case distinctions as well as the use of variables and formulas, this automation A2 of the total system can solve problems of the overall system of any desired complexity.

The exchange adapter represented in FIG. 9 consists of a nanorobot module 81, a mechanical fastening unit 82, consisting of guide 83 and rail 84, wherein a plug 85 on the rail 84 and a socket 86 as a counterpart to the electrical plug 85 is secured to cable set 87 on the guide 83. The only loosely attached plug 85 is pushed when the rail 84 is moved into the guide 83. In this process, the only loosely attached plug 85 pushes itself into the socket 86, also only loose fastened, each of which is subsequently mechanically completely fixed. Only in a following step does the fixing of the rail 84 in the guide 83 then take place, by means of the mechanical fastening unit 88.

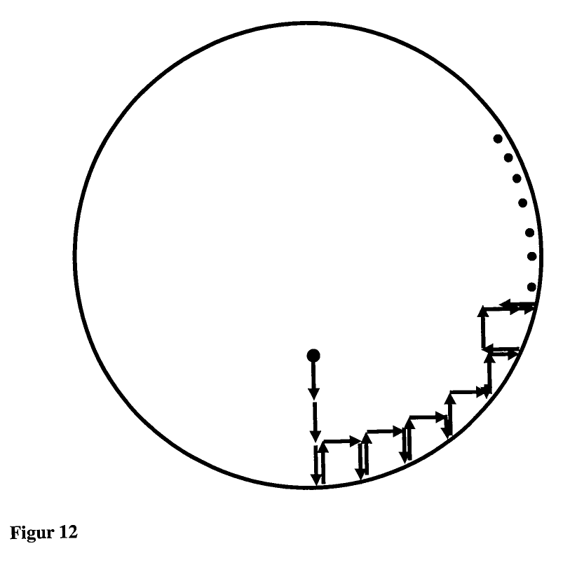

FIG. 10 shows the individual steps of the functional principle for surface measurement along a line. In step 1, the probe approaches without overshooting until in step 2 the probe detects the sample. Now, the position value of the approaching axis is stored. Subsequently a withdrawal takes place by a freely definable amount, preferably also in the controlled mode without overshoot, with the movement being discontinued on contact. These steps of this process can be repeated. Whether in this process the probe 1 approaches the sample 2, or the sample 2 approaches the probe, or both, makes no fundamental difference.

If, as shown in FIG. 11, the surface measurement takes place along many lines by the repeated use of the steps for approaching and measurement, a 3D dataset of the surface topography is obtained.

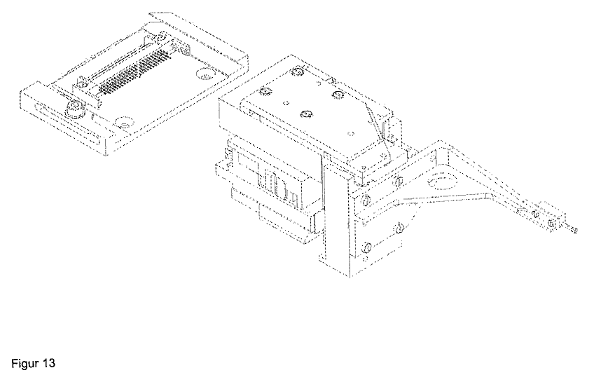

As shown in FIG. 12, the measurement method can also be applied to any desired shape of the internal contour. Here, the arrows show the movement of the measurement tip. Analogous to FIG. 8, many scans are

carried out next to one another, and thus a 3D dataset of internal and outside contours can also be generated here.

An exemplary embodiment of a nanorobot module is shown in FIG. 13.

What is claimed is:

1. A nanorobot module for the measurement of surface properties, with a drive device, wherein it has a measurement unit with a measurement probe with a resolution in the nanometer range and a measurement range in the centimeter range.

2. The nanorobot module according to claim 1, wherein the measurement probe is sensitive in several spatial directions.

3. The nanorobot module according to claim 1, wherein the measurement unit is movable along multiple dimensions.

4. The nanorobot module according to claim 1, wherein the drive device has piezoelectric or comparable drives.

5. The nanorobot module according to claim 1, wherein the drive device has position sensors.

6. The nanorobot module according to claim 6, wherein the position sensors have a resolution in the nanometer range.

7. The nanorobot module according to claim 1, wherein the drive device has a thermally compensated construction.

8. The nanorobot module according to claim 1, wherein the axial errors of the drive device are reduced to the nanometer range.

9. The nanorobot module according to claim 1, wherein the nanorobot module has a volume of less than 50×50×50 cm³.

10. The nanorobot module according to claim 1, wherein said nanorobot is suitable for operation in a vacuum.

11. The nanorobot module according to claim 1, wherein said nanorobot has multiple drives.

12. The nanorobot module according to claim 1, wherein said nanorobot has multiple probes.

13. The nanorobot module according to claim 1, wherein the nanorobot module has an end effector, with its own sensor properties and/or actuator properties and a sample can be approached by the probe.

14. The nanorobot module according to claim 13, wherein the nanorobot components, in particular end effectors or probes moved by them, have a storage device for state information especially about their size, composition, elevation, condition, design, electrical or mechanical parameters.

15. A system with a vacuum chamber in which a nanorobot module comprising a drive device, wherein it has a measurement unit with a measurement probe with a resolution in the nanometer range and a measurement range in the centimeter range is arranged, wherein the vacuum chamber has a free interior volume with an edge length less than 60 cm, preferably less than 30 cm.

16. System according to claim 15, wherein the nanorobot module is fastened to a chamber flange, to the chamber ceiling, chamber wall or a sample platform.

17. System according to claim 15, wherein the system has a computer or controller, which controls the individual steps of a measurement.

18. System according to claim 15, wherein the vacuum chamber and the nanorobot module respectively have a controller and the connection of the controllers has an interface.

19. System according to claim 15, wherein the interface is addressed by an automation system.

20. A method for using a nanorobot module comprising a drive device, wherein it has a measurement unit with a measurement probe with a resolution in the nanometer range and a measurement range in the centimeter range, said method comprising interrupting the touching or non-touching contact between measurement probe and sample during a measurement.

21. The method according to claim 20, further comprising: reducing the distance between measurement probe and sample until the touching or non-touching contact occurs and then stops.

22. The method according to claim 21, wherein if the contact of measurement probe and sample is not reached over the entire fine positioning range of the drive device, increasing the distance between probe and sample by a defined distance before a coarse approach step is made by less than this defined distance, and the reduction of the distance between probe and sample is repeated.

23. The method according to claim 21, wherein the position value on the approach line is stored.

24. The method according to claim 23, wherein the position value is modulated with the sensor value.

25. The method according to claim 22, wherein, in a subsequent step, increasing the distance from measurement probe to sample by a defined amount and moving the measurement probe by a defined distance to the side of the sample.

26. The method according to claim 25, further comprising repeating each step.

27. The method according to claim 20, wherein, until the touching or non-touching contact, moving the measurement probe to the side of the sample.

28. The method according to claim 20, further comprising measuring with the scanning method, in controlled contact with the sample.

29. The method according to claim 20, wherein a computer or controller controls each process step.

30. The method according to claim 20, wherein the measurement can be carried out along any spatial directions.

31. The method according to claim 20, wherein the measurement follows surface contours, and surfaces are scanned by means of rows of measurements.

32. The method according to claim 20, wherein the measurement data determined are sufficient to determine roughness values.

33. The method according to claim 20, wherein state information about the nanorobot components or end effectors moved by them is read out, which are automatically analysed, archived and in particular used for handling, measurement or automation processes.

34. An exchange adapter for exchanging nanorobot modules comprising a drive device, wherein it has a measurement unit with a measurement probe with a resolution in the nanometer range and a measurement range in the centimeter range, wherein said exchange adapter has an electrical connector system with a plug and a socket, and a mechanical fastening unit with a mechanical guide and a carriage.

35. The exchange adapter according to claim 34, wherein the socket of the electrical connector system can have a connection to the guiding system of the mechanical fastening unit and the plug can have a connection to the carriage of the mechanical fastening unit.

36. The method according to claim 34, wherein the connector and the socket are each mounted in a floating manner on the parts of the mechanical fastening unit.

37. The exchange adapter according to claim 36, wherein the floating mounting has so little play that the plug and socket can still center themselves securely, but simultaneously have enough play themselves such that in the mechanical fixing, little or no shearing forces are exerted on the electrical plug and socket connection.

38. The exchange adapter according to claim 34, wherein parts of the electrical plug and socket system have a fixing with the parts of the mechanical fastening unit.

39. The exchange adapter according to claim 34, wherein the plug and the socket have at least one plug-in contact.

40. The exchange adapter according to claim 34, wherein the mechanical fastening unit has a fixing for a carriage and guide.

41. The exchange adapter according to claim 34, wherein the guide has a precision of more than 300 microns.

42. The exchange adapter according to claim 34, wherein the guide has a play and vibrations of less than one micron, preferably in the range below 100 nanometers.

43. The exchange adapter according to claim 34, wherein the mechanical fastening device is manufactured from metal.

44. The exchange adapter according to claim 34, wherein the mechanical fastening device is produced from ceramic.

45. A method with an exchange adapter for exchanging nanorobot modules comprising a drive device, wherein it has a measurement unit with a measurement probe with a resolution in the nanometer range and a measurement range in the centimeter range, wherein said exchange adapter has an electrical connector system with a plug and a socket, and a mechanical fastening unit with a mechanical guide and a carriage, said method comprising: fixing and electrically connecting a measurement unit.

46. The method according to claim 45, further comprising: mechanically pre-fixing the plug connected to the measurement unit to the carriage, and mechanically pre-fixing the socket connected to the cable cord to the cable cord on a guide mechanism.

47. The method according to claim 45, wherein the carriage can be pushed into the guide in a manner such that the nanorobot module securely holds its position by itself.

48. The method according to claim 45, wherein the carriage is pushed further into the guide so that the connector and socket become electrically connected.

49. The method according to claim 45, wherein the plug connector and the carriage as well as the socket and the guide are finally mechanically fixed in a subsequent step.

50. The method according to claim 45, wherein the final fixing of the nanorobot module takes place at a reproducible position.

51. The method according to claim 45, wherein the final fixing of the nanorobot is effected in a maximally vibration-free manner.

52. The method according to claim 45, wherein the final fixing of the nanorobot module is effected in a stable manner.

53. A system with an exchange adapter for exchanging nanorobot modules comprising a drive device, wherein it has a measurement unit with a measurement probe with a resolution in the nanometer range and a measurement range in the centimeter range, wherein said exchange adapter has an electrical connector system with a plug and a socket, and a mechanical fastening unit with a mechanical guide and a carriage and with an additional basic part of this exchange device with a guide and socket, said system comprising at least one cable harness, at least one set of electronics and a vacuum chamber, wherein the nanorobot module with connector that is secured on the carriage and electrically connected can be connected to both basic parts.

54. A system with an exchange adapter for exchanging nanorobot modules comprising a drive device, wherein it has a measurement unit with a measurement probe with a resolution in the nanometer range and a measurement range in the centimeter range, wherein said exchange adapter has an electrical connector system with a plug and a socket, and a mechanical fastening unit with a mechanical guide and a carriage, wherein said a nanorobot module comprises an end effector, at least one cable harness, one set of electronics and a vacuum chamber, wherein the exchange adapter is arranged between the nanorobot module and the end effector.
